(19) United States
(12) Patent Application Publication
(10) Pub. No.: US 2024/0012179 A1
(43) Pub. Date: Jan. 11, 2024

(54) Optical Lens Including Optical Film Bonded to Lens Substrate

(71) Applicant: 3M INNOVATIVE PROPERTIES COMPANY, St. Paul, MN (US)

(72) Inventors: Adam D. Haag, Woodbury, MN (US); Kristy A. Gillette, Spring Valley, WI (US); John D. Le, Woodbury, MN (US); David J.W. Aastuen, Shoreview, MN (US)

(21) Appl. No.: 18/253,459

(22) PCT Filed: Nov. 16, 2021
(86) PCT No.: PCT/IB2021/060616

§ 371 Date: May 18, 2023

Related U.S. Application Data
(60) Provisional application No. 63/124,319, filed on Dec. 11, 2020.

(51) Int. Cl. G02B 1/04; G02B 5/28

(52) U.S. Cl. CPC G02B 1/041; G02B 5/287

(57) ABSTRACT

An optical lens includes a lens substrate including a cyclic olefin copolymer, an optical film including a plurality of alternating first and second polymeric layers, and a bonding film disposed on, and bonding the optical film to, a major surface of the lens substrate. The bonding film causes an average peel force to separate the optical film from the lens substrate to be greater than about 100 g/in while maintaining for at least one outermost major surface of the optical film, a mean displacement surface roughness Sa of less than about 10 nm and a slope magnitude error of less than about 100 μrad, and/or lower and higher spatial frequency slope magnitude errors each less than about 100 μrad.

### BACKGROUND

Optical lenses are useful in a variety of applications. For some applications, it is desired to dispose an optical film, such as a reflective polarizer film, on a major surface of a lens substrate.

### SUMMARY

The present description relates generally to an optical lens including an optical film bonded to a lens substrate with a bonding film. The optical film can be a multilayer optical film including a plurality of alternating polymeric layers and the lens substrate can be a cyclic olefin copolymer lens substrate. The bonding film can be adapted to bond the optical film to the lens substrate with a desired bond strength while maintaining desired low, or substantially no, surface texture in the optical film.

In some aspects of the present description, an optical lens is provided. The optical lens includes a lens substrate having opposed first and second major surfaces where at least one of the first and second major surfaces is curved. The lens substrate includes a cyclic olefin copolymer. The optical lens includes an optical film including a plurality of alternating first and second polymeric layers numbering at least 10 in total. Each of the first and second polymeric layers have an average thickness of less than about 500 nm. The optical lens includes a bonding film including a bonding layer having a composition other than a cyclic olefin polymer and other than a cyclic olefin copolymer and having a refractive index in a range of 1.45 to 1.6.

In some embodiments, the bonding film is disposed on, and bonds the optical film to, the first major surface and causes an average peel force to separate the optical film from the lens substrate to be greater than about 100 g/in while maintaining for at least one outermost major surface of the optical film, a mean displacement surface roughness Sa of less than about 10 nm and a slope magnitude error of less than about 100 rad.

In some embodiments, the bonding film is disposed on, and bonds the optical film to, the first major surface and causes an average peel force to separate the optical film from the lens substrate to be greater than about 100 g/in while maintaining for at least one outermost major surface of the optical film, lower and higher spatial frequency slope magnitude errors each less than about 100 rad. The lower and higher spatial frequency slope magnitude errors are determined from a surface profile filtered with respective lower and higher spatial frequency bandpass Fourier filters. The higher spatial frequency bandpass Fourier filter has band edge wavelengths of W1 and W2, and the lower spatial frequency bandpass Fourier filter has band edge wavelengths of W3 and W4, where 0.1 mm≤W1<W2≤W3<W4≤10 mm, W2≥2W1, and W4≥2W3.

These and other aspects will be apparent from the following detailed description. In no event, however, should this brief summary be construed to limit the claimable subject matter.

### BRIEF DESCRIPTION OF THE DRAWINGS

FIGS. 1-2 are schematic cross sectional views of optical lenses, according to some embodiments.

FIG. 3 is a schematic cross sectional view of an optical film, according to some embodiments.

FIG. 4 schematically illustrates determining various surface characterizations from a surface profile.

FIG. 5 schematically illustrates surface roughness and slope error.

FIGS. 6A-6C are schematic illustrations of bandpass Fourier filters, according to some embodiments.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

An optical lens with an optical film bonded to a lens substrate is useful in a wide variety of applications. For example, a reflective polarizer film bonded to a lens substrate is useful in optical systems utilizing a folded optics design as generally described in U.S. Pat. No. 10,678,052 (Ouderkirk et al.), for example. In some cases, it is desired to use a lens substrate formed of cyclic olefin copolymer (COC) due, for example, to desired optical properties of such materials such as low birefringence and/or low dispersion (change of refractive index with wavelength) and/or low haze. A COC lens substrate can be formed by insert injection molding COC resin onto the optical film or the optical film can be bonded to a previously formed lens substrate via an optically clear adhesive, for example. However, for multilayer optical films including a plurality or alternating polymeric layers, it has been found that it is difficult to achieve adequate bonding of the optical film to the lens substrate without also undesirably increasing the surface texture (e.g., roughness or waviness) of one or both outermost major surfaces of the optical film. For example, a wide range of adhesives may be included between the optical film and the lens substrate, but many such adhesives result in poor bonding and/or result in undesired surface texture in the optical film.

According to some embodiments of the present description, a bonding film can be disposed between the optical film and the lens substrate to provide a desired high peel force (e.g., greater than about 100 g/in) and a desired low surface texture (e.g., a mean displacement surface roughness Sa of less than about 10 nm and/or slope magnitude error(s) of less than about 100 rad) and desired optical properties (e.g., the bonding film can include a bonding layer adjacent the optical film that has a refractive index within about 0.1 of that the lens substrate). It has been found that suitable materials for a bonding layer includes a copolymer including ethylene and vinyl acetate groups, a copolymer including styrene and butadiene groups, and optically clear adhesives including a (meth)acrylate group having a linear alkyl chain including at least 4 carbons and having a glass transition temperature of no more than 25° C. The term “(meth)acrylate” is used to refer to both acrylate and methacrylate compounds. Solvent-deposited polymer layers, for example, have been found to result in low surface texture. Bonding layers having low glass transition temperatures (e.g., no more than 25° C. or no more than 0° C.) have been found to provide high adhesion to the optical film. In some embodiments, the bonding layer is or includes a (e.g., solvent-deposited) ethylene vinyl acetate, a (e.g., solvent-deposited) styrene butadiene rubber, or a (meth)acrylate including an acrylate group having a linear alkyl chain including at least 4 carbons, where the bonding layer has a glass transition temperature of no more than 25° C.

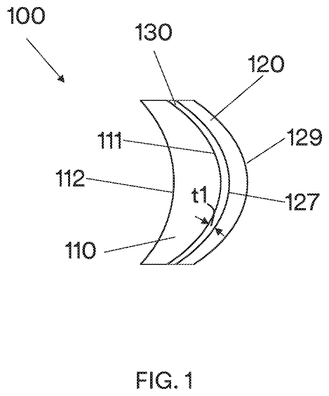

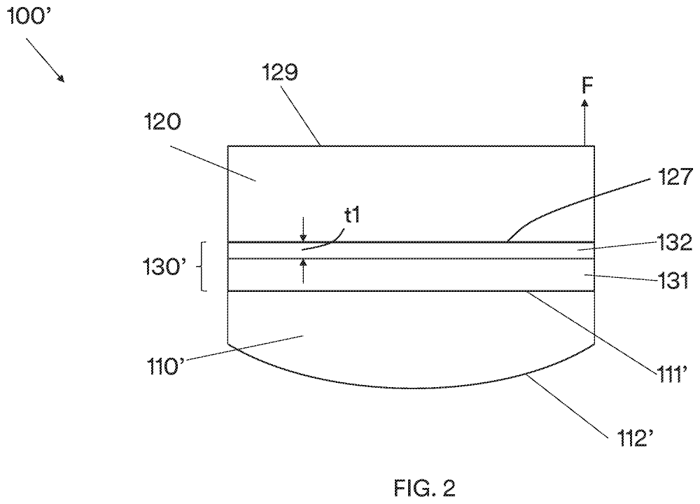

FIGS. 1 and 2 are schematic cross sectional views of optical lenses 100 and 100′, respectively, according to some embodiments. The optical lens 100 (resp., 100′) includes a lens substrate 110 (resp., 110′) having opposed first and second major surfaces 111 and 112 (resp., 111′ and 112′), an optical film 120, and a bonding film 130 (resp., 130′) disposed on, and bonding the optical film 120 to, the first major surface 111 (resp., 111′). The bonding film includes a bonding layer. In the embodiment illustrated in FIG. 1, the bonding film 130 is the bonding layer. In the embodiment illustrate in FIG. 2, the bonding film 130′ includes a carrier layer or substrate 131 in addition to a bonding layer 132. In other embodiments, the bonding film includes bonding layers on opposite sides of a carrier or substrate layer. The lens substrate 110 (resp., 110′) is typically formed from a cyclic olefin copolymer (COC). In some embodiments, the carrier layer or substrate 131 is an olefin substrate adapted to bond to the lens substrate when the lens is injection molded onto the bonding film. In some such embodiments, the bonding layer is selected to bond to both the olefin substrate and an outermost layer of the optical film. The bonding film typically directly contacts major surfaces of both the COC lens substrate and the optical film.

The lens substrate 110, 110′ can have any suitable geometry. For example, the lens substrate can be a biconvex, plano-convex, positive meniscus, negative meniscus, plano-concave, or biconcave lens substrate. The lens substrate can be a unitary or monolithic body. In the case of a compound lens, the lens substrate can refer to the lens element facing the optical film so that the bonding film bonds the optical film directly to the lens element which can be a unitary or monolithic body.

In some embodiments, the bonding film 103′ includes an olefin substrate 131 where the bonding layer 132 is disposed on, and substantially coextensive with, the olefin substrate 131 and where the bonding layer 132 faces the optical film 120. The substrate 131 can be a cyclic olefin polymer (COP) substrate, for example. Layers can be described as substantially coextensive with each other if at least about 60% by area of each layer is coextensive with at least about 60% by area of each other layer. In some embodiments, for layers describes as substantially coextensive, at least about 70%, or at least about 80%, or at least about 90% by area of each layer is coextensive with at least about 70%, or at least about 80%, or at least about 90% by area of each other layer. The bonding film can be a single bonding layer or can include a bonding layer and at least one other layer. The bonding film can be a self-supporting film (e.g., including a carrier and a bonding layer disposed on the carrier) or can be non-self-supporting (e.g., a bonding layer formed as a coating on the optical film, for example, may be a non-self-supporting film).

In some embodiments, the bonding layer has a composition other than a cyclic olefin polymer and other than a cyclic olefin copolymer. In other words, in some embodiments, the bonding layer is neither a cyclic olefin polymer nor a cyclic olefin copolymer. In some embodiments, the bonding layer has a refractive index close to that of the lens substrate. For example, the lens substrate may have a refractive index of about 1.53 while the bonding layer may have a refractive index in a range of 1.45 to 1.6, for example. The refractive index can be determined at a wavelength of about 589 nm (sodium D-line) and may be determined according to the ASTM D542-14 test standard, for example.

It has been found that suitable bonding layers include a copolymer including ethylene and vinyl acetate groups, a copolymer including styrene and butadiene groups, or certain optically clear adhesives such as those including, or based on, a (meth)acrylate such as a polymer including a (meth)acrylate group having a linear alkyl chain including at least 4 carbons, or at least 6 carbons, or at least 8 carbons and preferably having a glass transition temperature of no more than 25° C. In some embodiments, each (meth)acrylate group in at least 20 percent, or at least 50 percent by number of the (meth)acrylate groups of the polymer includes a linear alkyl chain including 4 carbons, or at least 6 carbons, or at least 8 carbons. Suitable (meth)acrylates include poly(n-butyl methacrylate) polymers such as ELVACITE 2044 or 4325 (available from Lucite International, Cordova, TN) or the acrylate adhesive available as CEF19 Contrast Enhancement Film (available from 3M Company, St. Paul, MN). In some embodiments, the bonding layer is or includes an optically clear adhesive including a long chain (meth)acrylate. As used herein, a long chain (meth)acrylate is a polymer including a (meth)acrylate group having a linear alkyl chain including at least 8 carbons. In some embodiments, each (meth)acrylate group in at least 20 percent, or at least 50 percent by number of the (meth)acrylate groups of the polymer includes a linear alkyl chain including at least 8 carbons, or at least 10 carbons, or at least 12 carbons, or at least 14 carbons. Long chain (meth)acrylates are described in U.S. Pat. Appl. Pub. No. 2018/0094173 (Everaerts), for example. Suitable copolymers including ethylene and vinyl acetate groups include the ethylene vinyl acetates (EVAs or VAEs) ELVAX 40W (available from Dow Chemical Company, Midland, MI), ATEVA 3325 and 4030 (available from Celanese, Irving, TX), DUR-O-SET E352 (available from Celanese, Irving, TX), and FLEXBOND 150 (available from Celanese, Irving, TX), for example. The vinyl acetate content in the ethylene vinyl acetate may be in a range of 10 to 80, or 20 to 50, or 30 to 45 mole percent, for example. Suitable copolymers including styrene and butadiene groups include the styrene butadiene rubber BUTOFAN NS 222 (available from BASF, Ludwigshafen, Germany), for example.

In some embodiments, the bonding layer is or includes a solvent-deposited polymer. Solvent-deposited polymers have been found to provide thin layers with low surface roughness and low slope magnitude error. A solvent-deposited layer is formed by coating a mixture (e.g., a solution or emulsion) of polymer and solvent and then removing the solvent. The solvent may be a solvent for the polymer or the polymer may be insoluble in the solvent (e.g., an aqueous emulsion of the polymer may be used). Suitable solvents include water, toluene, methyl ethyl ketone (MEK), alcohols, and glycol ethers (e.g., DOWANOL PM available from Dow Chemical Company) or combinations thereof.

In some embodiments, the bonding layer includes a substantially nonpolar polymer. In some embodiments, the bonding layer includes a polymer having a substantially aliphatic backbone (e.g., aliphatic or including aromatic groups at no more than about 10 mole percent). In some embodiments, the substantially aliphatic backbone includes aromatic groups at less than about 10 mole percent, or less than about 5 mole percent, or less than about 1 mole percent.

In some embodiments, the bonding layer has an average thickness t1 less than about 30 micrometers, or less than about 25 micrometers, or less than about 20 micrometers, or less than about 15 micrometers, or less than about 10 micrometers. In some such embodiments, or in other embodiments, the bonding layer has an average thickness of at least about 2 micrometers, or at least about 3 micrometers, or at least about 5 micrometers. For example, in some embodiments, the average thickness t1 is in arrange of about 2 micrometers to about 25 micrometers, or about 3 micrometers to about 20 micrometers. Typically, if the thickness of the bonding layer is too large, the surface texture of the optical film becomes too great when the optical film is bonded to the lens substrate and if the thickness of the bonding layer is too small, the bonding is to too weak. In some cases, the preferred thickness range can depend on the material of the bonding layer.

In some embodiments, the bonding layer has a glass transition temperature (Tg) of less no greater than 25° C., or no greater than 10° C., or no greater than 0° C., or no greater than −10° C., or no greater than −15° C., or no greater than −20° C. In some such embodiments, or in other embodiments, the glass transition temperature is at least −60° C., or at least −50° C., or at least −45° C. For example, in some embodiments, the glass transition temperature is in a range of −60° C. to 25° C. or to 0° C., or in a range of −45° C. to 0° C. The glass transition temperature can be determined by differential scanning calorimetry (DSC) as is known in the art. For example, the glass transition temperature can be determined as the onset temperature according to the ASTM E1356-08(2014) test standard. It has been found that lower (e.g., no greater than 25° C. or no greater than 0° C.) glass transition temperatures can result in improved bonding with low surface texture.

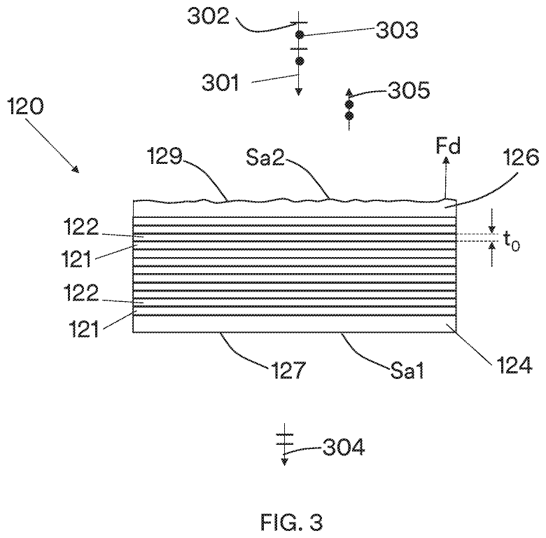

In some embodiments, the average peel force F (see, e.g., FIG. 2) to separate the optical film from the lens substrate is greater than about 100 g/in, or greater than about 300 g/n, or greater than about 500 g/in, or greater than about 700 g/in, or greater than about 900 g/in, or greater than about 1000 g/in. In some embodiments, the optical film includes a plurality of alternating first and second polymeric layers and the average peel force F to separate the optical film from the lens substrate is greater than an average interlayer delamination force Fd (see, e.g., FIG. 3) of the plurality of alternating first and second polymeric layers. The average peel force F (force per unit width) can be determined using a 90-degree peel test using a peel speed of 6 inches per minute and averaging over 5 seconds. The lens substrate may be held fixed and the optical film peeled along a fixed Cartesian direction defining a 90 degree peel angle at the center or apex of the major surface of the lens. The average interlayer delamination force Fd of the optical film can be determined using the same peel test as the average peel force F except that in testing delamination the optical film is scored by cutting at an angle with a razor blade before the peel test. A suitable delamination test method is described in U.S. Pat. No. 10,288,789 (Johnson et al.), for example.

FIG. 3 is a schematic cross sectional view of an optical film 120, according to some embodiments. The optical film 120 includes a plurality of alternating first and second polymeric layers 121 and 122 numbering at least 10 in total. The number of alternating first and second polymeric layers 121 and 122 may be substantially greater than schematically illustrated in FIG. 3. For example, the plurality of alternating first and second polymeric layers 121 and 122 may number at least 50, or at least 100, or at least 150 in total. In some embodiments, the plurality of alternating first and second polymeric layers 121 and 122 may number no more than 1000, or no more than 800 in total. Each of the first and second polymeric layers 121 and 122 has an average thickness (e.g., average thickness to) of less than about 500 nm, or less than about 400 nm, or less than about 300 nm. The optical film 120 includes first and second outermost layers 124 and 126 each of which may have an average thickness greater than about 500 nm, or greater than about 1 micrometer, or greater than about 2 micrometers.

The alternating first and second polymeric layers 121 and 122 may be selected to provide desired reflection and transmission spectra. As is known in the art, optical films including alternating polymeric layers can be used to provide desired reflection and transmission in desired wavelength ranges by suitable selection of layer thicknesses and refractive index differences. Multilayer optical films and methods of making multilayer optical films are described in U.S. Pat. No. 5,882,774 (Jonza et al.); U.S. Pat. No. 6,179,948 (Merrill et al.); U.S. Pat. No. 6,783,349 (Neavin et al.); U.S. Pat. No. 6,967,778 (Wheatley et al.); and U.S. Pat. No. 9,162,406 (Neavin et al.), for example.

In some embodiments, the optical film 120 is a reflective polarizer substantially transmitting (e.g., an average transmittance in the wavelength range of 450 nm to 650 nm of at least about 60%, or at least about 70%, or at least about 80%) substantially normally incident (e.g., within 20 degrees, or 10 degrees, or 5 degrees of normal) light 301 having a first polarization state 302 and substantially reflecting (e.g., an average reflectance in the wavelength range of 450 nm to 650 nm of at least about 60%, or at least about 70%, or at least about 80%) substantially normally incident light 301 having a second polarization state 303 orthogonal to the first polarization state 302. Transmitted light 304 and reflected light 305 are schematically illustrated in FIG. 3. Suitable reflective polarizers include, for example, 3M Advanced Polarizing Film (APF) available from 3M Company, St. Paul, MN. Other suitable optical films include those described in International Pat. Appl. No. WO 2020/012416 (Le et al.) and in U.S. Pat. Appl. Pub. No. 2020/0183065 (Haag et al.), for example.

In some embodiments, the optical film has a first outermost major surface 127 facing the lens substrate 110, 110′ and an opposite second outermost major surface 129 facing away from the lens substrate 110, 110′. In some embodiments, the first outermost major surface 127 has a lower mean displacement surface roughness than the second outermost major surface 129. For example, mean displacement surface roughness Sa1 and Sa2 of the first and second outermost major surfaces 127 and 129 are schematically illustrated in FIG. 3, according to some embodiments. In some embodiments, Sa1<Sa2, or Sa1<0.9 Sa2, or Sa1<0.8 Sa2, for example. In other embodiments, the first outermost major surface 127 has a higher mean displacement surface roughness than the second outermost major surface 129. The optical film 120 may be formed by coextrusion of the alternating polymeric layers along with outermost protective boundary layers and/or skin layers, casting the coextruded layers against a casting wheel, and then stretching the cast web. The outermost major surface of the optical film facing the casting wheel may have a higher surface roughness than the opposite outermost major surface. The optical film 120 may be oriented such that the rougher outermost major surface faces away from the lens substrate. In other embodiments, the first outermost major surface 127 has a higher mean displacement surface roughness than the second outermost major surface 129.

In some embodiments, the optical film 120 includes a first outermost layer 124 facing the bonding layer 130, 132. The optical film 120 can also include a second outermost layer 126 opposite the first outermost layer 124. In some embodiments, the first outermost layer 124, and in some cases the second outermost layer 126, includes polycarbonate. In some embodiments, the first outermost layer 124, and in some cases the second outermost layer 126, includes a blend of polycarbonate and copolyester.

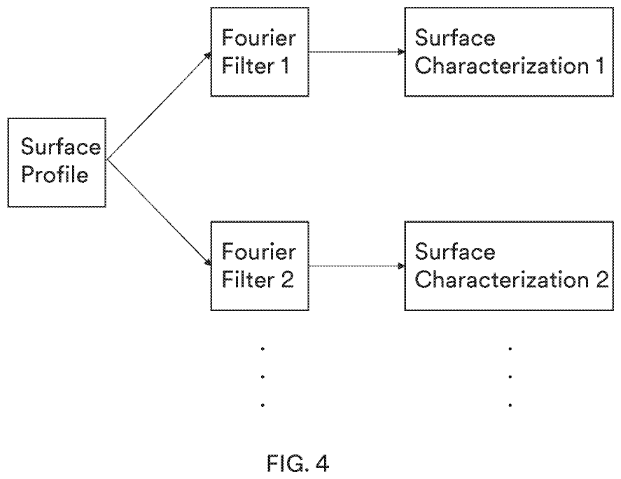

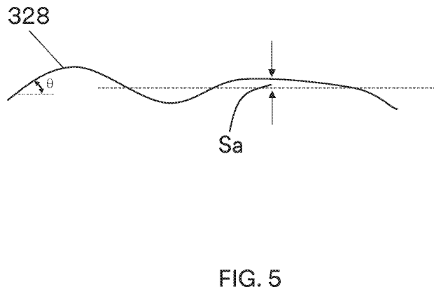

In some embodiments, the bonding film 130, 130′ causes an average peel force F to separate the optical film 120 from the lens substrate 110, 110′ to be greater than about 100 g/in while maintaining for at least one outermost major surface (e.g., outermost major surface 127 or 129) of the optical film 120, at least two surface characterizations in desired respective ranges. The at least two surface characterizations can include a mean displacement surface roughness Sa, which may be less than about 10 nm, for example. The at least two surface characterizations can include at least one slope magnitude error, which may be less than about 100 rad, for example. A slope magnitude error may be denoted <|θ|> to indicate a mean of the absolute value of the slope error. The at least two surface characterizations can include lower and higher spatial frequency slope magnitude errors <|θ|>_{L} and <|θ|>_{H}, each of which may be less than about 100 rad, for example. The at least two surface characterizations can be determined on at least two different length scales. FIG. 4 schematically illustrates starting with a surface profile (e.g., surface displacement profile for outermost major surface 127 or 129) and applying different Fourier filters (Fourier Filters 1, 2, etc.) to arrive at different surface characterizations (Surface Characterizations 1, 2, etc.). Surface Characterizations 1 and 2 may be Sa and <|θ|>, or <|θ|>_{L} and <|θ|>_{H}, for example. In some embodiments, Surface Characterizations 1 to 3 are determined which may be Sa, <|θ|>_{L} and <|θ|>_{H}, for example. FIG. 5 schematically illustrates a filtered surface profile 328 having a mean displacement surface roughness Sa and a slope error θ which can be described as the local slope of the surface relative to the desired surface. The average (unweighted mean) magnitude of θ is the slope magnitude error.

The slope magnitude error is determined from a surface profile filtered to remove level, spherical, cylindrical terms. As used herein, the slope magnitude error is determined from a surface profile further filtered to remove surface roughness length scales (e.g., less than about 0.3 mm, or less than about 0.1 mm) and long length scale error (e.g., form error on length scales greater than about 10 mm, or greater than about 5 mm, or greater than about 2 mm, or greater than about 1 mm). Slope magnitude error may also be referred to as the mid-spatial frequency slope error, or mid-wavelength slope error, or waviness. The slope magnitude error may be determined from a surface profile filtered with a passband Fourier filter having band edge wavelengths of W1 and W2, where 0.1 mm≤W1≤0.3 mm and W1≤W2≤10 mm, for example. In some embodiments, 2 W1≤W2 or 3W1≤W2. In some embodiments, W2≤5 mm, or W2≤2 mm, or W2≤1 mm. For example, in some embodiments, 3W1≤W2≤1 mm. In some embodiments, W1 is about 0.1 mm and W2 is about 0.3 mm, or W1 is about 0.3 mm and W2 is about 1 mm, or W1 is about 0.1 mm and W2 is about 1 mm. In some embodiments, the slope magnitude error is determined from a surface profile filtered with a passband Fourier filter having band edge wavelengths of about 0.1 mm and about 0.3 mm, or about 0.3 mm and about 1 mm, or about 0.1 mm and about 1 mm, for example. The slope magnitude error determined for any one or more of these frequency ranges may be less than 100 rad, or less than about 80 rad, or less than about 60 rad, or less than about 55 rad, or less than about 50 rad, for example. The slope magnitude error can be in a range of 5 rad to 100 rad or 10 rad to 60 rad, for example.

In some embodiments, slope magnitude errors are defined for at least two different spatial frequency ranges. For example, lower and higher spatial frequency slope magnitude errors may be determined from a surface profile filtered with respective lower and higher spatial frequency bandpass Fourier filters, where the higher spatial frequency bandpass Fourier filter has band edge wavelengths of W1 and W2 and the lower spatial frequency passband Fourier filter has band edge wavelengths of W3 and W4, and where 0.1 mm≤W1<W2≤W3<W4≤10 mm, W2≥2W1, and W4≤2W3. In some embodiments, W1 is about 0.1 mm, W2 and W3 are each about 0.3 mm, and W4 is about 1 mm, for example. The lower and higher spatial frequency slope magnitude errors can each less than about 100 rad, or can be in any range described elsewhere herein for slope magnitude errors, for example. In some embodiments, the lower spatial frequency slope magnitude error is less than the higher spatial frequency slope magnitude error. In some embodiments, the higher spatial frequency slope magnitude error is less than the lower spatial frequency slope magnitude error. In some embodiments, at least one of the higher and lower spatial frequency slope magnitude errors is less than about 60 rad, or less than about 55 rad, or less than about 50 rad, or less than about 45 rad, for example.

The mean displacement surface roughness Sa is determined from a surface profile filtered to remove level, spherical, cylindrical terms. As used herein, the mean displacement surface roughness Sa is determined from a surface profile further filtered to remove the length scales of the mid-spatial frequency slope error and longer length scales. For example, the slope magnitude error may be determined from a surface profile filtered with a passband Fourier filter having band edge wavelengths of W1 and W2, where 0.1 mm≤W1≤0.3 mm and W1≤W2≤10 mm, while the surface roughness may be determined from a surface profile filtered with a passband Fourier filter having band edge wavelengths of Wa and Wb, where Wa<Wb≤W1, or 1.5 Wa<Wb≤W1, or 2 Wa<Wb≤W1. In some embodiments, Wb is about 0.1 mm, or about 0.2 mm, or about 0.3 mm. In some such embodiments, or in other embodiments, Wa is about 0.06 mm, or about 0.05 mm, or about 0.04 mm. For example, in some embodiments, the mean displacement surface roughness Sa is determined from a surface profile filtered with a passband Fourier filter having band edge wavelengths of about 0.06 mm and about 0.1 mm. When lower and higher spatial frequency slope magnitude errors are determined, the mean displacement surface roughness Sa can be determined from a surface profile filtered to remove the length scales of both the lower and higher spatial frequency slope magnitude errors. In some embodiments, the mean displacement surface roughness Sa is less than about 10 nm, or less than about 8 nm, or less than about 6 nm, or less than about 5 nm. The mean displacement surface roughness Sa can be in a range of about 1 nm to about 10 nm, or to about 8 nm, for example.

The mean displacement surface roughness Sa and the slope magnitude errors can be determined as a mean over an area in a clear aperture of the lens and/or near a center of the film, for example. The area can be an approximately ellipsoidal or circular or rectangular or square area having dimensions (e.g., major and minor diameters or width and length) of at least the inverse of the smallest frequency passed by the Fourier filter. In some embodiments, an approximately square region having a width of about 4 mm is used.

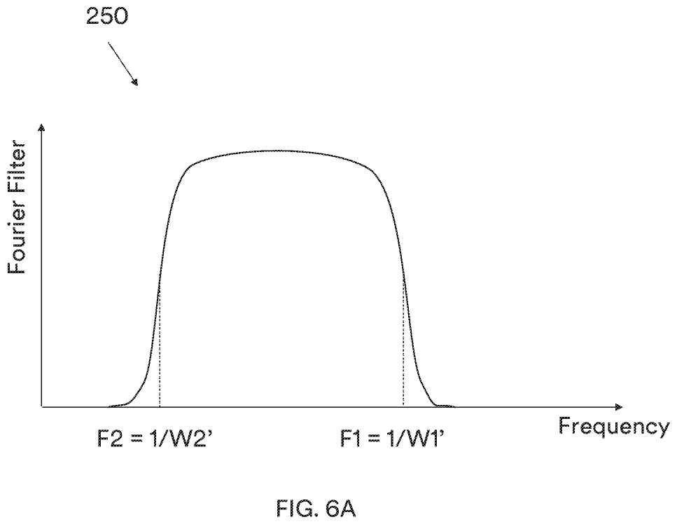

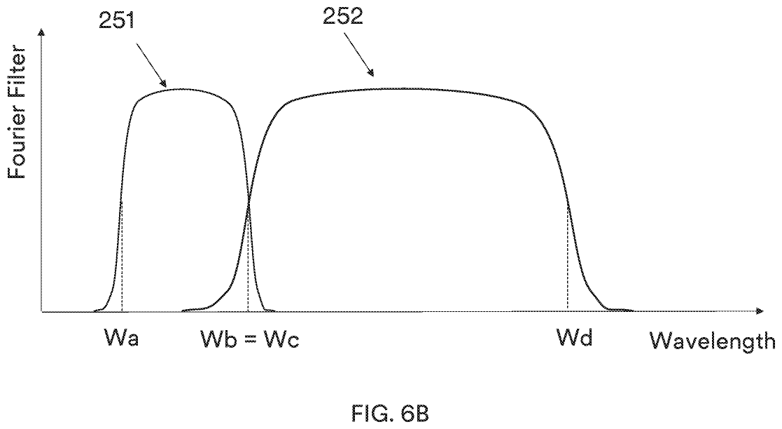

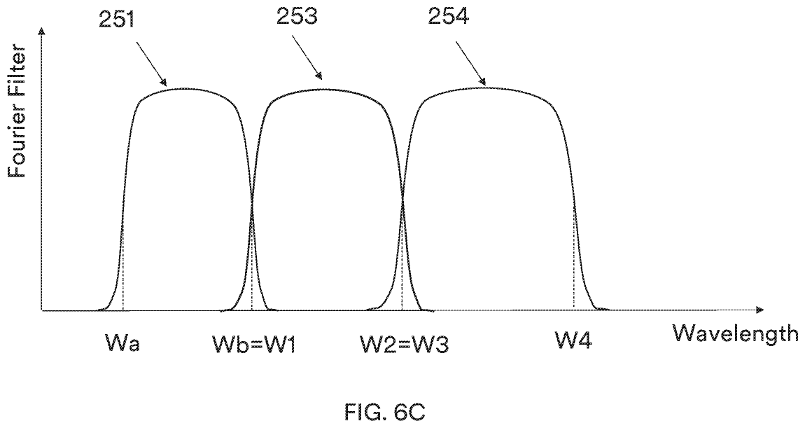

FIG. 6A is a schematic illustration of a bandpass Fourier filter 250 showing the magnitude of the filter versus spatial frequency, according to some embodiments. The bandpass Fourier filter 250 has band edge frequencies F1 and F2 and corresponding band edge wavelengths W1′ (related to the corresponding band edge frequency as 1/F1) and W2′ (related to the corresponding band edge frequency as 1/F2), which may correspond to the wavelengths W1 and W2, or W3 and W4, or Wa and Wb, described elsewhere herein. A Fourier filter can alternatively be plotted as a function of wavelength (inverse of spatial frequency). FIG. 6B is schematic illustration of bandpass Fourier filter 251 and 252 showing the magnitude of the filters versus wavelength, according to some embodiments. The bandpass Fourier filter 251 has band edge wavelengths Wa and Wb and may be used in defining a surface roughness Sa, for example. The bandpass Fourier filter 252 has band edge wavelengths We and Wd (which may alternatively be denoted W1 and W2) and may be used in defining a slope magnitude error, for example. In the illustrated embodiment, We=Wb. In other embodiments, We>Wb. FIG. 6C is a schematic illustration of the bandpass Fourier filter 251 and bandpass Fourier filters 253 and 254 showing the magnitude of the filters versus wavelength, according to some embodiments. The bandpass Fourier filter 253 has band edge wavelengths W1 and W2 and may be used in defining a higher spatial frequency (lower wavelength) slope magnitude error, for example. In the illustrated embodiment, W1=Wb. In other embodiments, W1>Wb. The bandpass Fourier filter 254 has band edge wavelengths W3 and W4 and may be used in defining a lower spatial frequency (higher wavelength) slope magnitude error, for example. In the illustrated embodiment, W3=W2. In other embodiments, W3>W2.

In some embodiments, an optical lens 100 (resp., 100′) includes a lens substrate 110 (resp., 110′) having opposed first and second major surfaces 111 and 112 (resp., 111′ and 112′) where at least one of the first and second major surfaces is curved and where the lens substrate 110 (resp., 110′) is or includes a cyclic olefin copolymer; an optical film 120 including a plurality of alternating first and second polymeric layers 121 and 122 numbering at least 10 in total where each of the first and second polymeric layers 121 and 122 has an average thickness (e.g., average thickness to) of less than about 500 nm; and a bonding film 130 (resp., 130′) including a bonding layer 130 (resp., 132) having a composition other than a cyclic olefin polymer and other than a cyclic olefin copolymer and having a refractive index in a range of 1.45 to 1.6.

In some embodiments, the bonding film 130 (resp., 130′) is disposed on, and bonds the optical film to, the first major surface 111 (resp., 111′) and causes an average peel force F to separate the optical film 120 from the lens substrate 110 (resp., 110′) to be greater than about 100 g/in while maintaining for at least one outermost major surface (e.g., outermost major surface 127 or outermost major surface 129, or both of the outermost major surfaces 127 and 129) of the optical film 120, a mean displacement surface roughness Sa (e.g., corresponding to Sa depicted in FIG. 5 or Surface Characterization 1 depicted in FIG. 4) of less than about 10 nm and a slope magnitude error (e.g., corresponding to the mean of the magnitude of the angle θ depicted in FIG. 5 or Surface Characterization 2 depicted in FIG. 4) of less than about 100 rad. In some embodiments, the slope magnitude error is determined from a surface profile filtered with a bandpass Fourier filter having band edge wavelengths of W1 and W2 (e.g., corresponding to wavelengths We and Wd depicted in FIG. 6B, or wavelengths W1 and W2 depicted in FIG. 6C, or wavelengths W3 and W4 depicted in FIG. 6C), where 0.1 mm≤W1≤0.3 mm, and 2W1≤W2≤10 mm, or where W1 and W2 are in any range described elsewhere herein.

In some embodiments, the bonding film 130 (resp., 130′) is disposed on, and bonds the optical film to, the first major surface 111 (resp., 111′) and causes an average peel force F to separate the optical film 120 from the lens substrate 110 (resp., 110′) to be greater than about 100 g/in while maintaining for at least one outermost major surface (e.g., outermost major surface 127 or 129) of the optical film 120, lower and higher spatial frequency slope magnitude errors (e.g., corresponding to Surface Characterizations 1 and 2 depicted in FIG. 4) each less than about 100 rad. The lower and higher spatial frequency slope magnitude errors are determined from a surface profile filtered with respective lower and higher spatial frequency bandpass Fourier filters (e.g., corresponding to Fourier filters 1 and 2 depicted in FIG. 4 or to Fourier filters 254 and 253 depicted in FIG. 6C), where the lower spatial frequency bandpass Fourier filter has band edge wavelengths of W1 and W2 and where the higher spatial frequency bandpass Fourier filter has band edge wavelengths of W3 and W4 (see, e.g., FIG. 6C). In some embodiments, 0.1 mm≤W<W2≤W3<W43≤10 mm, W2≤2W1, and W4≥2W3 or W1, W2, W3 and W4 can be in any range described elsewhere herein.

### Examples

Unless otherwise noted, all parts, percentages, and ratios reported in the following examples are on a weight basis.

Materials

| Name | Description | Supplier |
|---|---|---|
| ELVACITE 2046 | i-butyl/n-butyl Methacrylate | Lucite International, Cordova, TN |
| ELVACITE 4036 | Methacrylate Copolymer | Lucite International, Cordova, TN |
| DAOTAN 7010 | Polyurethane (PU) Dispersion | Allnex, Alpharetta, Georgia |
| MICHEM 5931 | Ethylene Acrylic Acid copolymer | Michelman, Inc., Cincinnati, OH |
| | (EAA) | |
| MICHEM 4983R | EAA | Michelman, Inc., Cincinnati, OH |
| ELVACITE 1010 | Methyl Methacrylate | Lucite International, Cordova, TN |
| | Macromonomer | |
| ELVACITE 4026 | Methyl Methacrylate Copolymer | Lucite International, Cordova, TN |
| ELVACITE 2016 | Methyl/n-butyl Methacrylate | Lucite International, Cordova, TN |
| | Copolymer | |
| MOWIOL 100-88 | Polyvinyl Alcohol (PVOH) | Kuraray Europe GmbH |
| ELVACITE 2042 | Ethyl Methacrylate | Lucite International, Cordova, TN |
| ELVACITE 2041 | Methyl Methacrylate | Lucite International, Cordova, TN |
| ELVACITE 2009 | Methyl Methacrylate | Lucite International, Cordova, TN |
| MOWIOL B20H | Polyvinyl Butryl (PVB) | Kuraray Europe GmbH |
| MOWIOL 28-99 | PVOH | Kuraray Europe GmbH |
| PERMUTHANE | Aliphatic, Polycarbonate-based | Stahl, Waalwijk, Netherlands |
| 21-502 | PU | |
| NEA-H | Acrylate Heat Activated Optically | 3M Company, St. Paul, MN |
| | Clear Adhesive (OCA), 8171 + | |
| | High Tg Polymer | |
| N50 | Sulfonated PET primer with | Made as described in U.S. Pat. |
| | corona treatment | No. 9,023,482 (Lockridge et al.) |
| WCF Primer | Polyurethane dispersion (PUD) | Made as described in U.S. Pat. |
| | primer | No. 10,723,918 (Chien et al.) |
| ELVACITE 2045 | i-Butyl Methacrylate | Lucite International, Cordova, TN |
| ELVAX 40W | EVA | Dow Chemical Company, |
| | | Midland, MI |
| ATEVA 3325 | EVA | Celanese, Irving, TX |
| ATEVA 4030 | EVA | Celanese, Irving, TX |
| DUR-O-SET E352 | VAE Emulsion | Celanese, Irving, TX |
| FLEXBOND 150 | VAE Emulsion | Celanese, Irving, TX |
| BUTOFAN NS 222 | Styrene Butadiene Rubber (SBR) | BASF, Ludwigshafen, Germany |
| | Emulsion (carboxylated) | |
| CEF19 | Long Chain Acrylate OCA - UV | 3M Company, St. Paul, MN |
| | curable | |
| CEF19 - UV cured | Long Chain Acrylate OCA - UV | 3M Company, St. Paul, MN |
| on substrate/liner | cured | |
| 8146 | Low Acid OCA | 3M Company, St. Paul, MN |
| ELVALOY HP662 | ethylene terpolymer (E/nBA/CO) | Dow Chemical Company, |
| | | Midland, MI |
| NEA-P | Acrylate (Acid containing) OCA | 3M Company, St. Paul, MN. |
| | available as 3M Optically Clear | |
| | Adhesive 8171 | |
| ELVACITE 2044 | Poly nButyl Methacrylate | Lucite International, Cordova, TN |
| ESCORENE | EVA | Exxon Mobil, Irving, TX |
| AD2528 | | |
| LOTADER | Ethylene-Methyl Acrylate- | SK Functional Polymer, |
| AX8900 | Glycidyl Methacrylate | Courbevoie, France |
| | Terpolymer | |
| ELVAX 3178Z | EVA | Dow Chemical Company, |
| | | Midland, MI |
| LOTRYL 35BA40 | Ethylene Butylacrylate | Arkema, Colombes, France |
| ELVACITE 4325 | Poly nButyl Methacrylate | Lucite International, Cordova, TN |
| PZ28 | Trimethylolpropane tris(2- | PolyAziridine LLC, Palm Beach, |
| | methyl-1-aziridine propionate) | FL |
| APEL 5014GH | Cyclic Olefin Copolymer (COC) | Mitsui, Tokyo, Japan |

A lens substrate was formed on an optical film via insert injection molding. Prior to injection molding, a bonding layer was applied to the optical film which was then placed into the mold. The optical film was a polymeric multilayer optical film reflective polarizer as described in Example 1 of International Pat. Appl. No. Wo 2020/012416 (Le et al.). The bonding layer was either applied directly to the optical film or was first applied to a release liner and then transferred to the optical film. The lens substrate formed from injection molding in these particular samples had a planar major surface facing the optical film and an opposite curved major surface. The following molding conditions were used:

| Material | APEL 5014GH |
|---|---|
| Press | Engel 180 Injection Molding Machine |
| Barrel | 25 mm |
| Cycle (sec) | 65 |
| Velocity (in/sec) | 1.1 |
| Fill Time (sec) | 0.88 |
| Pressure VP (psi) | 4336 |
| Screw Back (in) | 1.3 |
| Screw Suckback (in) | 0.1 |
| Back Pressure (psi) | 700 |
| Transfer (in) | 0.6 |
| Screw Delay | 5 |
| Screw Rotate (sec) | 3.8 |
| Cushion (in) | 0.19 |
| Hold Time (sec) | 30 |
| Hold Pressure (psi) | 16200 |
| Cool Time (sec) | 10 |
| Mold Temp Set A side (° F.) | 200 |
| Mold Temp Set B Side (° F.) | 200 |
| Mold Temp A Side (° F.) | 204 |
| Mold Temp B Side (° F.) | 202 |
| Barrel Temp 1 (° F.) | 500 |
| Barrel Temp 2 (° F.) | 515 |
| Barrel Temp 3 (° F.) | 500 |
| Barrel Temp 4 (° F.) | 480 |

Samples were tested for adhesion using packaging tape to judge “Pass” or “Fail”. Various passing samples were tested for average peel strength. A 90-degree peel test was used at a rate of 6 in/min and the peel force was averaged over 5 seconds. Surface profiles for samples which appeared to have low surface texture were determined and characterized as described below.

| | | Thickness | Average |
|---|---|---|---|
| | | of Bonding | Peel |
| Bonding Layer | Tg | Layer | Force |
| Material | (° C.) | (microns) | (g/in) |
| ELVACITE 2046 | 35 | 6 | Fail |
| ELVACITE 4036 | 59 | 12 | Fail |
| DAOTAN 7010 | | 10 | Fail |
| MICHEM 5931 (+PZ28) | | 10 | Fail |
| MICHEM 4983R (+PZ28) | | 10 | Fail |
| ELVACITE 1010 | 53 | 4 | Fail |
| ELVACITE 4026 | 75 | 5 | Fail |
| ELVACITE 2016 | 59 | 4 | Fail |
| MOWIOL 100-88 | | 2 | Fail |
| ELVACITE 2042 | 63 | 5 | Fail |
| ELVACITE 2041 | 105 | 4 | Fail |
| ELVACITE 2009 | 87 | 5 | Fail |
| MOWIOL B20H | 64 | 25 | Fail |
| MOWIOL 28-99 | 85 | 1 | Fail |
| PERMUTHANE 21-502 | | 38 | Fail |
| NEA-H | | 25 | Fail |
| N50 | 70 | 0.15 | Fail |
| WCF Primer | | 0.15 | Fail |
| ELVACITE 2045 | 55 | 12 | Fail |
| ELVAX 40W | −25 | 8 | 723 |
| ELVAX 40W | −25 | 16 | 1636 |
| ATEVA 3325 | −22 | 16 | 1369 |
| ATEVA 3325 | −22 | 6 | 414 |
| ATEVA 4030 | −25 | 24 | 1730 |
| ATEVA 4030 | −25 | 8 | 624.2 |
| DUR-O-SET E352 | −22 | 10 | 1341.2 |
| FLEXBOND 150 | −28 | 10 | 924.8 |
| BUTOFAN NS 222 | −26 | 16 | 567 |
| BUTOFAN NS 222 | −26 | 25 | 701 |
| CEF19 | −3 | 125 | Pass |
| CEF19 - UV cured | −3 | 125 | Pass |
| on substrate/liner | | | |
| 8146 | −5 | 25 | Pass |
| ELVALOY HP662 | −54 | 5 | 77 |
| NEA-P | | 9 | 158.9 |
| ELVACITE 2044 | 20 | 24 | 636.8 |
| ELVACITE 2044 | 20 | 6 | 117.9 |
| ESCORENE AD2528 | | 12 | 401.6 |
| LOTADER AX8900 | | 6 | 557.2 |
| LOTADER AX8900 | | 50 | Pass |
| ELVAX 3178Z | | 4 | 280.9 |
| LOTRYL 35BA40 | | 5 | 103.3 |
| ELVACITE 4345 | 20 | 18 | 225 |

Optical lenses including optical films were prepared via insert molding as described above using various solvent-deposited bonding layers. For the ELVACITE samples, the solvent was isopropyl alcohol (IPA). For the EVA samples, the solvent was either toluene or a blend of toluene and methyl ethyl ketone (MEK) ranging from 100% toluene to a 50/50 mixture of toluene and MEK For emulsions, the solvent was water. The average peel force was measured as described above. The outermost major surfaces of the bonded optical films were inspected for surface texture. If significant surface texture was observed, the surface texture was characterized as “poor”, otherwise the surface texture was characterized as “pass”. Results are reported in the following table. Some bonding layers were irradiated before injection molding the lens substrate onto the optical film as indicated in the table below by the radiation dose (in Mrad).

| | Bonding Layer | Average | |
|---|---|---|---|
| | Thickness | Peel Force | Surface |
| Bonding Layer Coating | (Microns) | (g/in) | Texture |
| ATEVA 3325 15% solids | 24 | 1984.6 | Poor |
| ATEVA 3325 15% solids | 16 | 1694.5 | Pass |
| ATEVA 3325 15% solids | 12 | 1096.2 | Pass |
| ATEVA 3325 12% solids | 12 | 707.6 | Pass |
| ATEVA 3325 12% solids | 9 | 668.1 | Pass |
| ATEVA 3325 12% solids | 6 | 413.8 | Pass |
| ATEVA 4030 15% solids | 24 | 1730 | Pass |
| ATEVA 403015% solids | 16 | 1205.5 | Pass |
| ATEVA 4030 15% solids | 12 | 1192 | Pass |
| ATEVA 4030 15% solids | 8 | 624.2 | Pass |
| ELVAX 40W 15% solids | 12 | 1135.6 | Pass |
| ELVAX 40W 15% solids | 8 | 711.7 | Pass |
| ELVAX 40W 20% solids | 16 | 1979.7 | Pass |
| ELVAX 40W 20% solids | 16.8 | 1734.2 | Pass |
| ELVAX 40W 20% solids | 16.8 | 1482.5 | Pass |
| ELVAX 40W 20% solids | 16 | 1733.7 | Pass |
| ELVAX 40W 20% solids | 17 | 1212.2 | Pass |
| ELVAX 40W 20% solids + | 12.5 | 38.24 | Pass |
| 6 Mrad | | | |
| ELVAX 40W 20% solids + | 12.5 | 40.3 | Pass |
| 9 Mrad | | | |
| ELVAX 40W 20% solids + | 12.5 | 6.9 | Pass |
| 12 Mrad | | | |

Optical lenses including an optical film bonded to a lens substrate via a bonding film were made as described above. The bonding film was prepared by coating a bonding layer prepared as indicated in the table below onto a cyclic olefin polymer (COP) substrate. The bonding films were then laminated to the optical film samples with the bonding layer facing the optical film. The lamination was carried out at room temperature (RT) or at 150° F. Insert molding was carried out with the lens substrate being formed on the olefin substrate opposite the optical film. The average peel force was measured as described above. Results are reported in the following table.

| | Bonding | | Average |
|---|---|---|---|
| | Layer | Lamination | Peel |
| Bonding Layer | Thickness | Temp | Force |
| Coating | (microns) | (° F.) | (g/in) |
| ELVACITE 2044 | 17 | RT | 41 |
| 20% solids | | | |
| ELVACITE 2044 | 17 | RT | 41.4 |
| 20% solids | | | |
| ELVACITE 2044 | 12 | RT | 23.2 |
| 20% solids | | | |
| ELVACITE 2044 | 17 | RT | 11.2 |
| 20% solids | | | |
| ELVACITE 2044 | 10 | 150 | 108.1 |
| ELVACITE 2044 | 15 | 150 | 90.4 |
| ELVACITE 2044 | 24 | 150 | 636.8 |
| ELVACITE 2044 | 6 | 150 | 117.9 |
| 18% solids | | | |
| ELVACITE 2044 | 15 | 150 | 95.1 |
| 18% solids | | | |
| ELVACITE 2044 | 18 | 150 | 241.3 |
| 18% solids | | | |
| ELVACITE 2044 | 12 | 150 | 215.1 |
| 18% solids | | | |

Optical lenses including an optical film bonded to a lens substrate with a bonding film including a bonding layer and an olefin substrate were prepared as described above using the various solvent-deposited bonding layers indicated in the table below. The bonding film was laminated to the optical film at room temperature. The surface profile for the outermost surface facing away from the lens substrate was measured over a roughly square shaped region having a width of about 4 mm using a white light interferometer (available from Bruker Corporation, Billerica, MA). The mean displacement surface roughness Sa and slope magnitude errors were determined from the surface profile. The surface profile was filtered using a Fourier filter having passband edge wavelengths of 0.06 mm and 1 mm in determining the mean displacement surface roughness Sa. The surface profile was filtered using various Fourier filters having passband edge wavelengths as indicated in the table below in determining the slope magnitude error.

| | | | | Slope | Slope | Slope |
|---|---|---|---|---|---|---|
| | | | | Mag. | Mag. | Mag. |
| | | Bonding | | Error | Error | Error |
| | | Layer | | (μrad) | (μrad) | (μrad) |
| | % | Thickness | Sa | 0.1 mm | 0.3 mm | 0.1 mm |
| Solution | solids | (microns) | (nm) | to 0.3 mm | to 1 mm | to 1 mm |
| ELVAX | 20 | 18.3 | 5.2 | 150.7 | 40.2 | 164.6 |
| 40W | | | | | | |
| ELVAX | 20 | 13.3 | 5 | 144.9 | 45.2 | 160.4 |
| 40W | | | | | | |
| ATEVA | 15 | 17 | 3.6 | 108.5 | 43.5 | 122.8 |
| 3325 | | | | | | |
| ATEVA | 15 | 11 | 4 | 99.6 | 29 | 108.8 |
| 3325 | | | | | | |
| ATEVA | 15 | 16 | 3.9 | 115.4 | 52.6 | 137.3 |
| 3325 | | | | | | |
| ATEVA | 15 | 9 | 5.4 | 178 | 55.3 | 195.9 |
| 3325 | | | | | | |
| ATEVA | 15 | 10 | 2 | 72.7 | 54.7 | 102.4 |
| 3325 | | | | | | |
| ATEVA | 15 | 10 | 4.5 | 126.3 | 44.9 | 141.9 |
| 3325 | | | | | | |
| ATEVA | 15 | 15.7 | 4.9 | 160.9 | 49.8 | 176.3 |
| 3325 | | | | | | |
| ATEVA | 15 | 25 | 5.1 | 154.3 | 63.4 | 171.7 |
| 3325 | | | | | | |
| BUTOFAN | 50 | 25 | 1.75 | 62.3 | 71.6 | 102 |
| NS 222 | | | | | | |

Other samples made with BUTOFAN NS 222 and having thickness of 16 microns or less resulted in poor adhesion.

Optical lenses including an optical film bonded to a lens substrate with a bonding film including a bonding layer and a COP substrate were prepared as described above using the various solvent-deposited bonding layers indicated in the table below. The bonding film was laminated to the optical film at 150° F. The mean displacement surface roughness Sa and slope magnitude errors were determined as described above. Results are reported in the following table.

| | | | | Slope | Slope | Slope |
|---|---|---|---|---|---|---|
| | | | | Mag. | Mag. | Mag. |
| | | Bonding | | Error | Error | Error |
| | | Layer | | (μrad) | (μrad) | (μrad) |
| | % | Thickness | Sa | 0.1 mm | 0.3 mm | 0.1 mm |
| Solution | solids | (microns) | (nm) | to 0.3 mm | to 1 mm | to 1 mm |
| ELVAX | 20 | 16.7 | 1.5 | 48.6 | 54.1 | 80.5 |
| 40W | | | | | | |
| ELVAX | 20 | 15.3 | 1.2 | 45.8 | 77.7 | 98 |
| 40W | | | | | | |
| ELVAX | 20 | ~17 | 1.6 | 72.5 | 72.3 | 106.7 |
| 40W | | | | | | |
| ELVAX | 20 | ~25 | 1.8 | 61.8 | 167.3 | 174.1 |
| 40W | | | | | | |

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations, or variations, or combinations of the specific embodiments discussed herein. Therefore, it is intended that this disclosure be limited only by the claims and the equivalents thereof.

1-15. (canceled)

16. An optical lens comprising:
a lens substrate having opposed first and second major surfaces, at least one of the first and second major surfaces being curved, the lens substrate comprising a cyclic olefin copolymer;
an optical film comprising a plurality of alternating first and second polymeric layers numbering at least 10 in total, each of the first and second polymeric layers having an average thickness of less than about 500 nm; and
a bonding film comprising a bonding layer having a composition other than a cyclic olefin polymer and other than a cyclic olefin copolymer and having a refractive index in a range of 1.45 to 1.6, the bonding film disposed on, and bonding the optical film to, the first major surface and causing an average peel force to separate the optical film from the lens substrate to be greater than about 100 g/in while maintaining for at least one outermost major surface of the optical film, a mean displacement surface roughness Sa of less than about 10 nm and a slope magnitude error of less than about 100 μrad.

17. The optical lens of claim 16, wherein the slope magnitude error is determined from a surface profile filtered with a bandpass Fourier filter having band edge wavelengths of W1 and W2, 0.1 mm≤W1≤0.3 mm, 2W1≤W2≤10 mm.

18. The optical lens of claim 16, wherein the slope magnitude error is determined from a surface profile filtered with a bandpass Fourier filter having band edge wavelengths of about 0.1 mm and about 0.3 mm.

19. The optical lens of claim 16, wherein the slope magnitude error is determined from a surface profile filtered with a bandpass Fourier filter having band edge wavelengths of about 0.3 mm and about 1 mm.

20. The optical lens of claim 16, wherein the slope magnitude error is determined from a surface profile filtered with a bandpass Fourier filter having band edge wavelengths of about 0.1 mm and about 1 mm.

21. The optical lens of claim 16, wherein the slope magnitude error is less than about 60 μrad and the mean displacement surface roughness Sa is less than about 6 nm.

22. The optical lens of claim 16, wherein the optical film comprises a first outermost layer facing the bonding layer, the first outermost layer comprising polycarbonate.

23. The optical lens of claim 16, wherein the bonding film comprises an olefin substrate, the bonding layer disposed on, and substantially coextensive with, the olefin substrate, the bonding layer facing the optical film.

24. The optical lens of claim 16, wherein the bonding layer comprises a solvent-deposited polymer.

25. The optical lens of claim 16, wherein the bonding layer has a glass transition temperature no greater than 25° C.

26. The optical lens of claim 16, wherein the bonding layer comprises an ethylene vinyl acetate, a styrene butadiene rubber, or a (meth)acrylate comprising an acrylate group having a linear alkyl chain comprising at least 4 carbons.

27. An optical lens comprising:
a lens substrate having opposed first and second major surfaces, at least one of the first and second major surfaces being curved, the lens substrate comprising a cyclic olefin copolymer;
an optical film comprising a plurality of alternating first and second polymeric layers numbering at least 10 in total, each of the first and second polymeric layers having an average thickness of less than about 500 nm; and
a bonding film comprising a bonding layer having a composition other than a cyclic olefin polymer and other than a cyclic olefin copolymer and having a refractive index in a range of 1.45 to 1.6, the bonding film disposed on, and bonding the optical film to, the first major surface and causing an average peel force to separate the optical film from the lens substrate to be greater than about 100 g/in while maintaining for at least one outermost major surface of the optical film, lower and higher spatial frequency slope magnitude errors each less than about 100 μrad, the lower and higher spatial frequency slope magnitude errors determined from a surface profile filtered with respective lower and higher spatial frequency bandpass Fourier filters, the higher spatial frequency bandpass Fourier filter having band edge wavelengths of W1 and W2, the lower spatial frequency bandpass Fourier filter having band edge wavelengths of W3 and W4, 0.1 mm≤W1<W2≤W3<W4≤10 mm, W2≥2W1, W4≥2W3.

28. The optical lens of claim 27, wherein W1 is about 0.1 mm, W2 and W3 are each about 0.3 mm, and W4 is about 1 mm.

29. The optical lens of claim 27, wherein the at least one outermost major surface of the optical film has a mean displacement surface roughness Sa of less than about 10 nm.

30. The optical lens of claim 27, wherein at least one of the lower and higher spatial frequency slope magnitude errors is less than about 60 μrad.

31. The optical lens of claim 27, wherein the optical film comprises a first outermost layer facing the bonding layer, the first outermost layer comprising polycarbonate.

32. The optical lens of claim 27, wherein the bonding film comprises an olefin substrate, the bonding layer disposed on, and substantially coextensive with, the olefin substrate, the bonding layer facing the optical film.

33. The optical lens of claim 27, wherein the bonding layer comprises a solvent-deposited polymer.

34. The optical lens of claim 27, wherein the bonding layer has a glass transition temperature no greater than 25° C.

35. The optical lens of claim 27, wherein the bonding layer comprises an ethylene vinyl acetate, a styrene butadiene rubber, or a (meth)acrylate comprising an acrylate group having a linear alkyl chain comprising at least 4 carbons.
